(19) United States
(12) Patent Application Publication
(10) Pub. No.: US 2024/0070518 A1
(43) Pub. Date: Feb. 29, 2024

(54) SMART COMMUNICATION IN FEDERATED LEARNING FOR TRANSIENT AND RESOURCE-CONSTRAINED MOBILE EDGE DEVICES

(71) Applicant: Dell Products L.P., Round Rock, TX (US)

(72) Inventors: Paulo Abelha Ferreira, Rio de Janeiro (BR); Pablo Nascimento da Silva, Niterói (BR); Vinicius Michel Gottin, Rio de Janeiro (BR)

(21) Appl. No.: 17/822,488

(22) Filed: Aug. 26, 2022

(51) Int. Cl. G06N 20/00; G06K 9/62

(52) U.S. Cl. CPC G06N 20/00; G06K 9/6262

(57) ABSTRACT

One example method includes transmitting, by a central node to each edge node in a group of edge nodes, a quantization level, receiving, by the central node from each of the edge nodes, a respective gradient vector, wherein each gradient vector has been quantized according to the quantization level, re-quantizing, by the central node, the gradient vectors that have been received from the edge nodes, wherein the gradient vectors are re-quantized by the central node to a lower quantization level than the quantization level, validating, by the central node, the quantization level and the lower quantization level, and based on an outcome of the validating, automatically adjusting the quantization level.

### FIELD OF THE INVENTION

Embodiments of the present invention generally relate to federated learning systems and processes. More particularly, at least some embodiments of the invention relate to systems, hardware, software, computer-readable media, and methods for implementing a smart quantization scheme for use in transmission of gradients from edge nodes to a central node.

### BACKGROUND

Some settings in which federated learning (FL) is implemented may involve transient mobile edge devices, such as autonomous vehicles driving through, and passing, a given city or location of interest. These mobile devices, even though running large models, might be resource-constrained in relation to training machine learning (ML) models. For example, a self-driving vehicle might have to make decisions about allocation of its computational and energy resources to the different ML models it is training and running, and to its various sensors and devices.

Thus, implementation of FL in such environments may be confronted with various challenges. For example, participant devices can join/drop in and out of the federation. Thus, it may not be possible to rely on a single device participating, nor can the devices be indexed. As another example, participant nodes are typically resource constrained and, as such, those participants cannot be relied upon to perform significant amounts of computation. Finally, network usage, such as may be required in communications between edge devices and a central node, must be kept to a minimum due to bandwidth constraints and/or size of the model(s) deployed on the edge devices.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example federated learning setting.

FIG. 2 discloses an example sign compressor for compressing a gradient vector.

FIG. 3 discloses a flowchart of an example method for implementing a quantization protocol.

FIG. 4 discloses a re-quantization from an original 16-bit level down to all specified lower levels.

FIG. 5 discloses aspects of a computing entity operable to perform any of the disclosed methods, processes, and operations.

### DETAILED DESCRIPTION OF SOME EXAMPLE EMBODIMENTS

Embodiments of the present invention generally relate to federated learning systems and processes. More particularly, at least some embodiments of the invention relate to systems, hardware, software, computer-readable media, and methods for implementing a smart quantization scheme for use in transmission of gradients from edge nodes to a central node.

In general, some example embodiments of the invention may implement a smart quantization scheme, where a central node will bet every cycle on the quantization it supposes to be best. Since participants, such as edge nodes, may not be indexable, clustering approaches for the participants may not be useful for determining quantization needs and parameters. Further, since the participants may be resource constrained, such as in terms of processing power and available memory for example, the computation to quantize and decide on the best quantization may be performed at the central node. The quantization, that is, compression of gradients created and transmitted by the edge nodes in connection with the operation of an ML model, may be implemented at least in view of limitations on network speed and bandwidth between the edge nodes and the central node where the ML model is maintained and updated. In some embodiments, the central node may gather a validation dataset for use in determining the quantization approach to take. Thus, some embodiments are directed to a smart federated learning quantization scheme that switches between quantization levels according to its performance on a central validation dataset and periodically resets the quantization to a less optimistic one to help improve convergence.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, some embodiments of the invention may operate to take best advantage of available network resources in devising a quantization scheme for communication of data and information from edge nodes to a central node. An embodiment may strike a balance between an acceptable level of model convergence, which may be a function of the size of a gradient vector, and available network resources for transmitting the gradients, edge node resources, and edge node mobility. Various other advantages of some example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Context

The following is a discussion of aspects of example operating environments for various embodiments of the invention. This discussion is not intended to limit the scope of the invention, or the applicability of the embodiments, in any way.

Federated Learning (FL) is a Machine Learning (ML) technique capable of providing model training from distributed devices while keeping their data private. This can be of great value for a business since the business may be able to train machine learning models for a variety of distributed edge devices and apply them to products, such as laptops, servers, and storage arrays, for example. A provider of model training may benefit from providing solutions and infrastructure for customers in this domain, and using it internally in its own products.

Some settings in Federated Learning may involve transient mobile edge devices, such as autonomous vehicles driving through, and passing, a given city or location of interest. These mobile devices, even though running large models, might be resource-constrained in relation to training ML models. For example, a self-driving vehicle might have to make decisions on computational and energy resource allocation to its different ML models and other sensors and devices.

In this setting, some example embodiments may implement Federated Learning while facing three main challenges: (1) edge nodes, such as participant devices, may be able to join in and out of the federation—thus no single participant may be relied on, and the participants may not be indexable; (2) edge nodes may be resource-constrained—thus, the edge nodes may not be able to be relied upon for performing any significant amounts of computation; and (3) there may be a need or requirement to maintain network usage at a minimum, such as due to bandwidth constraints and/or size of the model(s) running at the edge nodes.

### B. Overview

A goal of federated learning may be to train a centralized global ML model while the training data remains distributed on many edge nodes. In this context, embodiments may employ a central node that may be any system, machine, and/or software, with adequate computational power. Training a model in a Federated Learning setting may be performed as follows.

Initially, the central node may share an initial model, such as a deep neural network, with all the distributed edge nodes. Next, the edge nodes may train their models using their own data, and without sharing their data with other edge nodes. Then, the central node receives the updated models from the edge nodes and aggregates those updated models into a single central model. The central node may then communicate the new, updated, model to the edge nodes, and the process may repeat for multiple iterations until it reaches convergence.

In practice, updating the central model may involve frequently sending from the edge nodes each gradient update, that is, the respective updates to the model that have been made by the edge nodes. This approach may imply large bandwidth requirements for large models. Hence, an optimization in federated learning may be to compress the weights of transmitted data, such as the gradients, in both directions of communication—that is, the edge node compresses the model updates, or gradients, sent to the central node, and the central node compresses the updated model to be broadcast to the edge nodes for the next training cycle.

Applying aggressive compression—such as down to one bit per weight for example—may be an efficient trade-off between communication overhead and model convergence speed. However, there are cases where the non-quantized, non-compressed updates could result in a sufficiently faster convergence rate to justify the higher communication costs. The development of methods for intelligently compressing gradients is desirable for FL applications, especially where it can be done by deciding when to send a compressed gradient and when to send an uncompressed gradient, while preserving the convergence rate and accuracy.

### C. Federated Learning

### C.1 FL Process

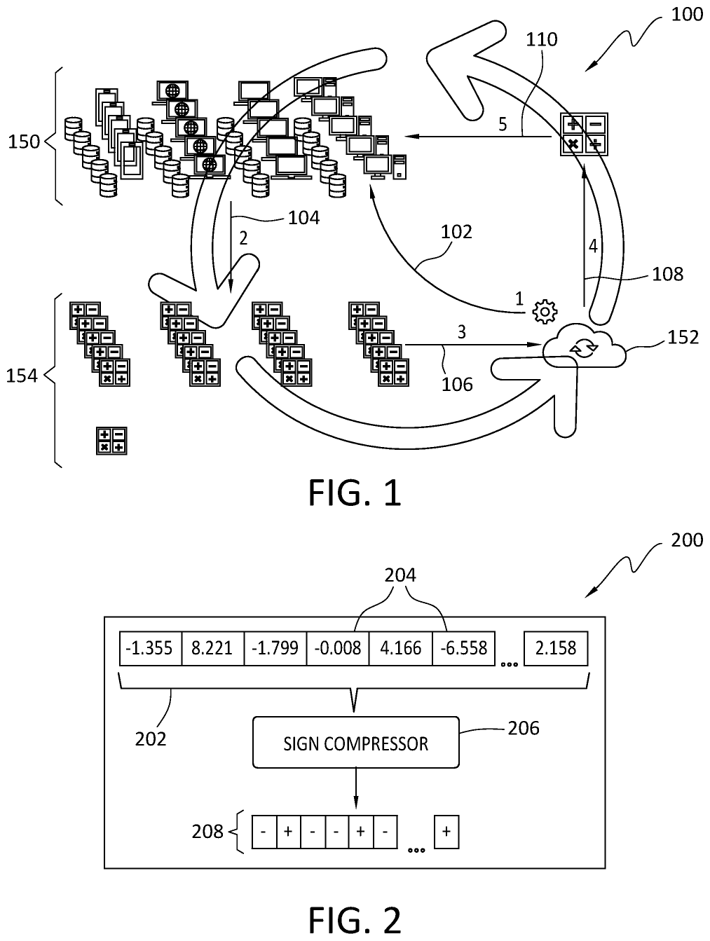

With reference now to FIG. 1, details are provided concerning aspects of an example federated learning process and system such as may be employed in some embodiments. Federated learning (FL) is a machine learning technique where the goal is to train a centralized model while the training data remains distributed on many client nodes. Usually, the network connections and the processing power of such client nodes are unreliable and slow. One of the ideas behind FL is that client nodes, or edge nodes, can collaboratively learn a shared machine learning model, typically a deep neural network, while keeping the training data private on the client device, so the model can be learned without storing a huge amount of data in the cloud, or in the central node. Every process with many data-generating nodes may benefit from such an FL approach, and these processes are countless in the mobile computing world we live in nowadays.

In the context of federated learning, a central node may be any machine, system, and/or software, with reasonable computational power, that receives the updates from the client nodes and aggregates these updates on the shared model. A client node may be any device or machine that contains data that will be used to train the machine learning model. Examples of client nodes include, but are not limited to, connected cars, IoT (Internet of Things) devices, autonomous systems and vehicles, mobile phones, storage systems, and network routers.

Turning now to FIG. 1, there is disclosed a process 100 for the training of a neural network in a federated learning setting. This process 100, which may be performed in iterations that may be referred to as cycles, may proceed as follows.

Initially, the client nodes 150 download 102 the current model from the central node 152. If it is the first cycle, the shared model may be randomly initialized. Then, each client node 150 trains the model using its local data during a user-defined number of epochs. The model updates 154 are generated 104 and then sent 106 from the client nodes 150 to the central node 152. In at least some embodiments of the invention, these model updates 154 may comprise vectors containing the gradients, that is, the changes that the client nodes 150 have made to the model. The central node 152 may aggregate these vectors and update 108 the shared model. If the predefined number of cycles N is reached, finish the training. Otherwise, the updated model may then be transmitted 110 to the client nodes 150.

### C.2 Compression Techniques for Federated Learning

Various methods may be used to reduce the communication cost of federated learning algorithms. One of the strongest for gradient compression is the SIGNSGD with majority voting. One such method allows sending 1-bit per gradient component, which is a 32× gain compared to a standard 32-bit floating-point representation. However, this method may be inadequate to reduce the compression without impacting the convergence rate or final accuracy. FIG. 2 depicts an example of a compression technique 200 that may be employed in some example embodiments. This compression technique is referred to as a sign method of compressing a vector formed by float numbers. Particularly, a gradient vector 202 may comprise various elements 204 that each have a sign and magnitude. This gradient vector 202 may be processed by a sign compressor 206 that strips out the magnitude information, thus creating a gradient vector 208 that includes only signs. The gradient vector 208 may be referred to as a compressed gradient vector since it contains some, but not all, of the information in the initial uncompressed gradient vector 202.

### D. Further Aspects of Some Example Embodiments

As noted earlier herein, some example embodiments may deal with three different constraints in implementing a smart quantization scheme, where the central node will bet every cycle on the quantization the central node supposes to be best. These constraints may comprise: (1) participants, such as edge nodes, are not indexable, therefore, it may not be possible to use any clustering approaches to cluster the participants; (2) the participants may be highly resource constrained and, as such, the computation to quantize and decide on the best quantization may have to be performed at the central node; and (3) there may be a need like to minimize network usage and, accordingly, the gradients may be need to be compressed, that is, quantized. Some embodiments may operate such that the central node can gather a small, but representative, validation dataset.

Note that as used herein, ‘quantization’ and its variations include, but are not limited to, processes in which values from a large data set (the input) are mapped to values in a relatively smaller data set (the output). Depending upon the way in which quantization is implemented, a set of data may be reduced in size so that the reduced size data set still retains, to an acceptable extent, certain properties of the full data set, such as a property that enables convergence of an ML model that is updated using the reduced size data set. As another example, a quantization process may involve processes that reduce the size of a data set, such as by way of sign compression, as disclosed herein.

### D.1 Quantization Protocol

Some embodiments may implement an adaptive quantization protocol that uses a validation set at the central node to decide on the next best bet for the quantization level. Example quantization protocol methods according to some embodiments may include various processes and elements.

In one embodiment, the first process may be to decide on an initial quantization value, for instance, 16 for a 16-bit quantization. That is, some embodiments might start with a high quantization level in order to be the least optimistic about how much information is needed from the gradients in order to train the ML model well. The 16-bit quantization level is one halving away from the maximum 32-bit quantization level. Being least optimistic means that an embodiment might in fact choose the maximum level of a 32-bit quantization. The actual chosen value may be determined either from past experiences on setting initial values for a given domain, or from just taking the least optimistic option of the highest quantization level.

After deciding on an initial quantization level, embodiments may implement a setup of initial values for the main control variables of the quantization protocol. The main control variable is ‘r’ for the number of federated learning rounds, or cycles, that are run before testing for a possibly better quantization level. Then, embodiments may keep track of the number of rounds ‘c’ since the last effective quantization—that is, since the quantization level was last modified to a better one. Thus, embodiments may start with c←0.

According to some embodiments, the next process in the example quantization protocol method may be to gather and prepare a validation dataset for the central node. This dataset may come from the same domain as the ones being used locally to train the models at the edge nodes. Central validation datasets may be gathered from the edge nodes themselves as examples without privacy requirements, or with a small amount of added noise, or may come from a similar process that is possible to run at the central node. In any case, some embodiments may assume that the central validation node is a reasonable dataset gathered from the same domain as the ones at the edge nodes. Note that Xie, Cong, Sanmi Koyejo, and Indranil Gupta. “Zeno++: Robust fully asynchronous sgd.” International Conference on Machine Learning. PMLR, 2020 (“Xie”) discloses an example of a method of using a central validation node operating in connection with a centralized validation dataset, and Xie is incorporated herein in its entirety by this reference.

After the various components have been set up, an example quantization protocol may be as follows:
a. Ifc>r, make the current quantization to one quantization level above the previous one (e.g., 16-bit to 32-bit);
b. Central node communicates current quantization level;
c. Edge nodes perform a training round and compress their gradients using the current quantization level;
d. Central node receives quantized gradients and re-quantizes the results to all lower levels of quantization (e.g., 8-, 4- and 2-bit quantization if $b is 16);
e. If one of the smaller quantization levels yields better central validation results, that level is adopted as the new quantization level and c←0;
f. Else, c←c+1

### D.2 Example Quantization Protocol Methods

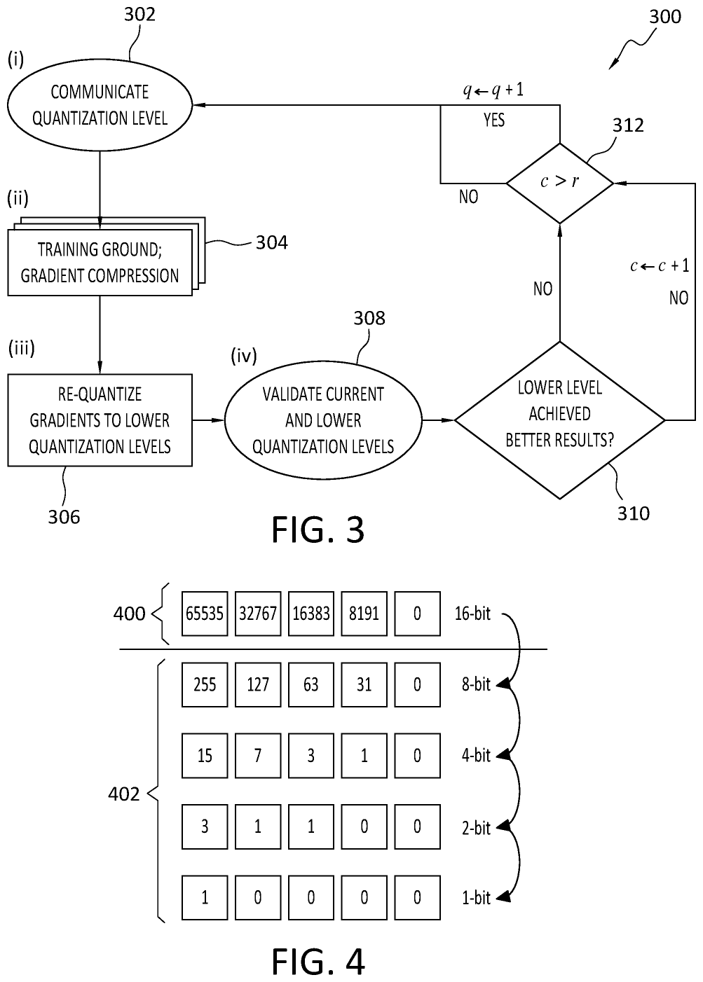

With reference now to FIG. 3, an example method 300 according to some embodiments is disclosed. In general, the method 300 comprises various operations in an example implementation of a quantization protocol, where the round flowchart nodes in FIG. 3 relate to central node computations and operations, and the square nodes in FIG. 3 indicate edge node computations and operations. It is noted with respect to the example method 300 that the method may run on top of any suitable federated learning protocol(s), such as may be known in the art.

The example method 300 may begin at 302 where the round is started by communication, by the central node, of the current quantization level to be used by all edge nodes. At 304, the edge nodes train their models and then quantize the gradients using the current quantization level that was received at 302. Next, the central node may quantize 306 received, from the edge nodes, the gradients according to all quantization levels below the current one. The re-quantization may comprise calculating a proportional quantization from one level to another. With reference briefly to FIG. 4, there is disclosed an example of re-quantization, such as may be performed at 306, for a 5-dimensional gradient vector 400 currently quantized at the 16-bit level. Particularly, FIG. 4 discloses, by way of example, re-quantization from an original 16-bit level down to all specified lower quantization levels, in this case, to respective gradient vectors 402 at the 8-bit, 4-bit, 2-bit, and 1-bit, quantization levels. This re-quantization 306 may be performed with very low resource, that is, processing and memory, requirements.

With continued reference now to FIG. 3, the method 300 may continue with the aggregation 308 of the gradients at each quantized level, and the testing of the different versions of the model against the validation dataset. That is, testing may be performed as part of 308 to determine 310 if any of the lower quantization levels achieves better results than the current quantization level. If so, and if it is determined 312 thatc>r, then this ‘winning’ lower quantization level q+1 may become the new quantization level to be communicated by the central node to the edge nodes in the next round of the method 300. If it is determined at 312 that c is not >r, then the quantization level may remain unchanged.

On the other hand, at 310, if any of the lower quantization levels do not achieve better results than the current quantization level, then embodiments may increment a counter c of “no-winning-lower-quantization” to c+1. If this counter is determined at 312 to have achieved its r limit of number of rounds, then the quantization may be reset to one level above the current quantization level.

As disclosed herein, including in the discussion of FIG. 3, some example embodiments are directed to a smart Federated learning quantization scheme that is able to switch between quantization levels according to the performance of one or more particular quantization levels on a central validation dataset. As well, such embodiments may periodically reset the quantization level to a less optimistic quantization level so as to help improve convergence of the model whose gradients are being sent from the edge nodes to the central node in accordance with the quantization level(s).

### E. Example Methods

It is noted with respect to the disclosed methods, including the example method 300 of FIG. 3, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments of the invention. These are presented only by way of example and are not intended to limit the scope of the invention in any way.

Embodiment 1. A method, comprising: transmitting, by a central node to each edge node in a group of edge nodes, a quantization level; receiving, by the central node from each of the edge nodes, a respective gradient vector, wherein each gradient vector has been quantized according to the quantization level; re-quantizing, by the central node, the gradient vectors that have been received from the edge nodes, wherein the gradient vectors are re-quantized by the central node to a lower quantization level than the quantization level; validating, by the central node, the quantization level and the lower quantization level; and based on an outcome of the validating, automatically adjusting the quantization level.

Embodiment 2. The method as recited in embodiment 1, wherein one or more of the edge nodes comprises a respective mobile edge device.

Embodiment 3. The method as recited in embodiment 1, wherein the quantizing comprises performing sign compression on the gradient vectors.

Embodiment 4. The method as recited in embodiment 1, wherein automatically adjusting the quantization level comprises automatically adjusting the quantization level to the lower quantization level.

Embodiment 5. The method as recited in embodiment 1, wherein the validating comprises determining, as between the quantization and lower quantization level, which quantization level enables better performance of a machine learning model with which the gradient vectors are associated.

Embodiment 6. The method as recited in embodiment 1, wherein automatically adjusting the quantization level is based in part on bandwidth constraints and/or a size of a machine learning model with which the gradient vectors are associated.

Embodiment 7. The method as recited in embodiment 1, wherein the method is an element of a federated learning process for a machine learning model, and the central node defines and selects the quantization level due at least in part to a lack of adequate computing resources at the edge nodes.

Embodiment 8. The method as recited in embodiment 1, wherein one of the gradient vectors comprises a change that one of the edge nodes has made to a machine learning model deployed at that edge node.

Embodiment 9. The method as recited in embodiment 1, wherein the edge nodes are able to enter, or leave, at any time, a federation that includes the edge nodes.

Embodiment 10. The method as recited in embodiment 1, wherein: when the validating indicates that the lower quantization level yields better performance, relative to the quantization level, of a machine learning model with which the gradient vectors are associated, the lower quantization level is adopted, and a counter set to zero; and when a value of the counter is greater than a number of federated learning cycles that are run before testing a different quantization level, the quantization level is w increased to a higher quantization level.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

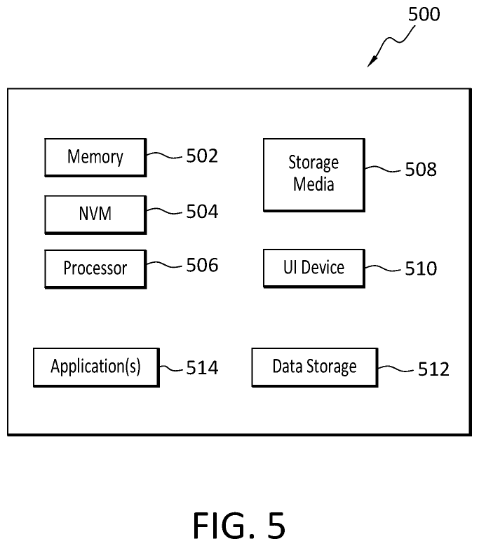

With reference briefly now to FIG. 5, any one or more of the entities disclosed, or implied, by FIGS. 1-4 and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI (user interface) device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
transmitting, by a central node to each edge node in a group of edge nodes, a quantization level;
receiving, by the central node from each of the edge nodes, a respective gradient vector, wherein each gradient vector has been quantized according to the quantization level;
re-quantizing, by the central node, the gradient vectors that have been received from the edge nodes, wherein the gradient vectors are re-quantized by the central node to a lower quantization level than the quantization level;
validating, by the central node, the quantization level and the lower quantization level; and
based on an outcome of the validating, automatically adjusting the quantization level.

2. The method as recited in claim 1, wherein one or more of the edge nodes comprises a respective mobile edge device.

3. The method as recited in claim 1, wherein the quantizing comprises performing sign compression on the gradient vectors.

4. The method as recited in claim 1, wherein automatically adjusting the quantization level comprises automatically adjusting the quantization level to the lower quantization level.

5. The method as recited in claim 1, wherein the validating comprises determining, as between the quantization and lower quantization level, which quantization level enables better performance of a machine learning model with which the gradient vectors are associated.

6. The method as recited in claim 1, wherein automatically adjusting the quantization level is based in part on bandwidth constraints and/or a size of a machine learning model with which the gradient vectors are associated.

7. The method as recited in claim 1, wherein the method is an element of a federated learning process for a machine learning model, and the central node defines and selects the quantization level due at least in part to a lack of adequate computing resources at the edge nodes.

8. The method as recited in claim 1, wherein one of the gradient vectors comprises a change that one of the edge nodes has made to a machine learning model deployed at that edge node.

9. The method as recited in claim 1, wherein the edge nodes are able to enter, or leave, at any time, a federation that includes the edge nodes.

10. The method as recited in claim 1, wherein:
when the validating indicates that the lower quantization level yields better performance, relative to the quantization level, of a machine learning model with which the gradient vectors are associated, the lower quantization level is adopted, and a counter set to zero; and
when a value of the counter is greater than a number of federated learning cycles that are run before testing a different quantization level, the quantization level is increased to a higher quantization level.

11. A non-transitory storage medium having stored therein instructions that are executable by one or more hardware processors to perform operations comprising:
transmitting, by a central node to each edge node in a group of edge nodes, a quantization level;
receiving, by the central node from each of the edge nodes, a respective gradient vector, wherein each gradient vector has been quantized according to the quantization level;
re-quantizing, by the central node, the gradient vectors that have been received from the edge nodes, wherein the gradient vectors are re-quantized by the central node to a lower quantization level than the quantization level;
validating, by the central node, the quantization level and the lower quantization level; and
based on an outcome of the validating, automatically adjusting the quantization level.

12. The non-transitory storage medium as recited in claim 11, wherein one or more of the edge nodes comprises a respective mobile edge device.

13. The non-transitory storage medium as recited in claim 11, wherein the quantizing comprises performing sign compression on the gradient vectors.

14. The non-transitory storage medium as recited in claim 11, wherein automatically adjusting the quantization level comprises automatically adjusting the quantization level to the lower quantization level.

15. The non-transitory storage medium as recited in claim 11, wherein the validating comprises determining, as between the quantization and lower quantization level, which quantization level enables better performance of a machine learning model with which the gradient vectors are associated.

16. The non-transitory storage medium as recited in claim 11, wherein automatically adjusting the quantization level is based in part on bandwidth constraints and/or a size of a machine learning model with which the gradient vectors are associated.

17. The non-transitory storage medium as recited in claim 11, wherein the operations comprise elements of a federated learning process for a machine learning model, and the central node defines and selects the quantization level due at least in part to a lack of adequate computing resources at the edge nodes.

18. The non-transitory storage medium as recited in claim 11, wherein one of the gradient vectors comprises a change that one of the edge nodes has made to a machine learning model deployed at that edge node.

19. The non-transitory storage medium as recited in claim 11, wherein the edge nodes are able to enter, or leave, at any time, a federation that includes the edge nodes.

20. The non-transitory storage medium as recited in claim 11, wherein:
when the validating indicates that the lower quantization level yields better performance, relative to the quantization level, of a machine learning model with which the gradient vectors are associated, the lower quantization level is adopted, and a counter set to zero; and
when a value of the counter is greater than a number of federated learning cycles that are run before testing a different quantization level, the quantization level is increased to a higher quantization level.
